(19) United States
(12) Patent Application Publication
(10) Pub. No.: US 2013/0215440 A1
(43) Pub. Date: Aug. 22, 2013

(54) Method And Apparatus For Calibrating And Profiling Colored Media Given An Inkset On A Printer Using White Ink And An Apparatus And Automatic Method For Color Separating And Printing On Colored Background Using White Ink

(71) Applicant: Maheshwari Sanjay Chandermohan, Gujarat (IN)

(72) Inventor: Maheshwari Sanjay Chandermohan, Gujarat (IN)

(21) Appl. No.: 13/818,328

(22) PCT Filed: Jul. 14, 2011
(86) PCT No.: PCT/IN2011/000468

§ 371 Date: May 3, 2013

(51) Int. Cl. G06K 15/02

(52) U.S. Cl. CPC G06K 15/021
USPC 358/1.9

(57) ABSTRACT

An embedded system for calibrating and profiling colored media using an inkset, white ink and an online or offline printing device for printing. The system includes an embedded apparatus capable of generating, adapting, and printing the targets required for calibrating and profiling. The printing involves generation of white ink data and suitable separations for printing inkset for the target to be printed on the colored media. A dual-acting device capable of acting as a plate making or film generating means for offline printing, and as a print controller for online printing may be used. The printing device may be selected from an offset printing device or a screen printing device when offline printing and/or an inkjet printer or a laser printer when online printing.

### FIELD OF INVENTION

The present invention relates to a method and apparatus for calibrating and profiling the colored media given an inkset on a printer using white ink. The invention further relates to an apparatus and automatic method for color separating and printing on colored background using white ink.

### BACKGROUND OF INVENTION

Printing on colored background using white ink has been around for a long time using screen printing. It is a relatively a new phenomenon to use inkjet printing methods to print on colored media using white ink.

Inkjets are capable of producing very sharp image definitions in comparison to screen printing. Printing using inkjet process has been quite successful for various applications like paper, photography, signage etc. One thing common here in most of these applications is the use of white background for printing. Various techniques are known in the art for profiling these media having white background using a set of inks and a printing process[2][3].

If printing is done on colored background using solid white layer underneath the colors, a colored media can be calibrated and profiled using these available tools in the market. Currently this process of printing over solid white layer is used by screen printing industry.

However, research indicates that the colored background itself can be used as a color participating in the printing process with the help of adapting the white ink application on the colored media. This can either significantly increase the color gamut or reduce the printing cost by acting as a replacement for any of the printing primary or both. Further if black color ink is used in printing, more savings can be achieved by varying the amount of white ink applied corresponding to the amount of black ink.

There prior art is silent on the technology to profile the colored media using white ink in the manner described above that can be applied to all types of printing methods whether employing this technique online or offline.

The existing methods of calibrating and profiling the media using an inkset on a printer are available only for white media or white background. Medias having slight tints but are close to white are also included in the definition of white. Examples of such Medias are white plain paper, newspaper having white background etc.

According to a method disclosed by Power et al. [1], the yellow paper typically used in yellow pages can be used as an ink in the color separation process. Their method is however limited to the disclosed purpose and does not involve the use of white ink. Further this method can only be used with 2 special colors+additional black color and the yellow background. This method at best can be extended to other light colored backgrounds with the same restriction on inks as in case of yellow background. Their method will fail if printing is done on a background that has any color but yellow, light or white background. For example this method will fail on black background or orange background. Further the limitation of this known process is that it can only support 2 colors+black ink only.

A more generic solution is to use the white ink to print on the colored background. However, the prior art doesn't offer or suggests how to take advantage of the background color in color profiling.

At best the prior art offers techniques to profile colored media using an inkset, when solid white underbase is printed.

The process of printing in any form involves separation of the input image into color separations representing the inks used for printing. Generation of these color separations is based upon the calibration and profiling data generated for the particular printing process using specific inkset and media. Hence for successful and accurate printing of images the process of calibration and profiling is very important.

### OBJECTS OF THE INVENTION.

This invention has two main objectives,
(1)To describe the method and apparatus for calibrating and profiling the colored media using an inkset and white ink on a printer; and
(2)To describe the improved method and apparatus for printing on colored background as a consequence of achievements/teachings of objective (1).

### Hence,

An object of this invention is to propose a method for calibrating and profiling an inkset on colored background using white ink.

Another object of this invention is to propose a method for calibrating and profiling an inkset on colored background using white ink, which is enabled to use the colored background adapted in combination with white ink as an ink participating in color formation during the printing process.

A yet another object of this invention is to propose a method for calibrating and profiling an inkset on colored background using white ink, with optimized use of white ink if black ink is used for printing by adapting the use of white ink in combination with black ink amount.

A still another object of the invention is to propose an apparatus for calibrating and profiling an inkset on coloured background using white ink.

A further object of the invention is to propose an automatic method for printing on coloured background using white ink.

A still further object of the invention is to propose an automatic method for printing on coloured background using white ink, which is enabled to generate white underbase for the automatic printing.

Yet another object of the invention is to propose an automatic method for printing on coloured background using white ink, which is enabled to generate color-separations for the automatic printing.

Yet another object of the invention is to propose an apparatus for printing on coloured background using white ink.

### SUMMARY OF THE INVENTION

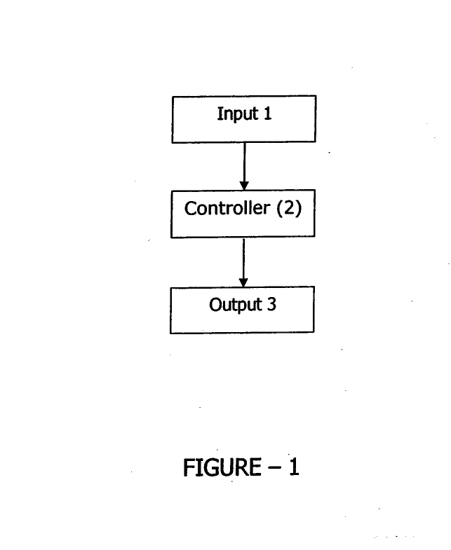

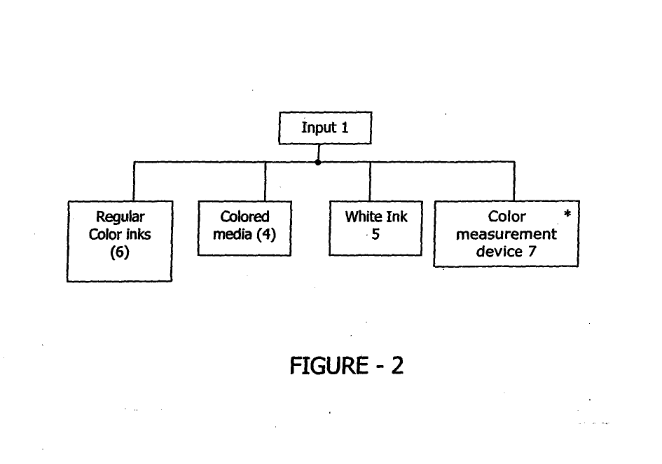

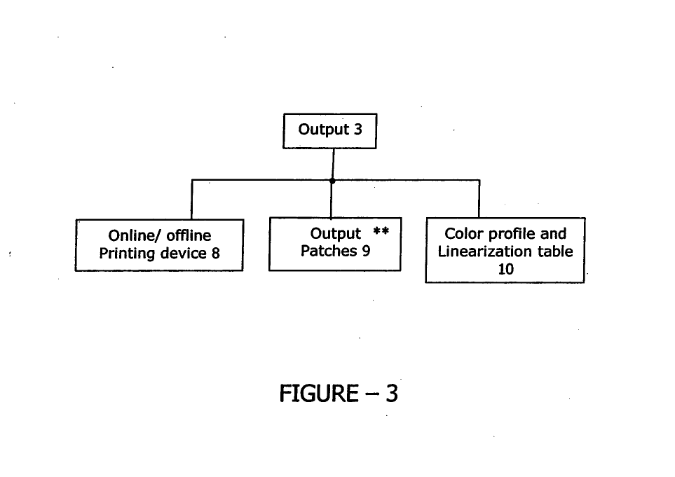

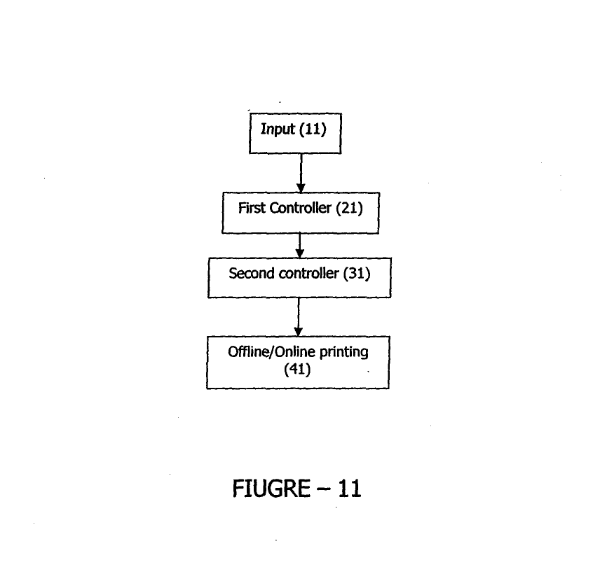

Following are some definitions that are commonly used throughout the invention.
[Definition 1—Ink] In the context of this invention the definition of “ink” includes not only fluid containing color pigment/dye but also the powder toners like the ones used by laser printers. In general Ink in the context of this invention will refer to any chemical that can impart color when applied to a substrate irrespective of its form and application method.
[Definition 2—Inkset] In the context of this invention “inkset” is defined as any combination of inks that can be used for printing like but not limited to CMYK, CMYKOG, CMYKOB, CMYKRGB, CMYKLcLm, RGBK etc, where C denotes Cyan, M denotes Magenta, Y denotes Yellow, K denotes Black, O denotes Orange, G denotes Green, B denotes Blue, R denotes Red, Lc denotes Light Cyan, Lm denotes Light Magenta and so on. Throughout this invention inkset is used to refer to any such combination of inks defined by this definition.
[Definition 3—Online printing device] For the purpose of this invention, an online printing device is the device that can make utilization of the printing data generated by the controlling devices labeled controller (2) (FIG. 2) and a first controller (21) (FIG. 11) directly without needing any physical intermediate like plate or screen or film or cylinders or transfer media etc. Example of such devices are inkjet printer, laser printer etc.
[Definition 4—Offline printing device] For the purpose of this invention, an offline printing device is the device that can make utilization of the printing data generated by the controlling devices labeled Controller (2) (FIG. 1) and a first controller (21) (FIG. 11) only with the help of a physical intermediate like plate or screen or film or cylinders or transfer media etc. Examples of such devices are offset printing machine, screen printing machine etc.
[Definition 5—Target] In context of calibration and profiling, Target or Targets when used in plural denotes the color chart(s) with specific color swatches. Based on the context of use this definition assumes meaning otherwise target is to be interpreted in literal sense.

Since, in printing the ink amount used is generally expressed in terms of percentages, hence we will also refer to the same unit throughout this invention.

Accordingly, in a first aspect of the invention there is provided an embedded system for calibrating and profiling the colored media using an inkset, white ink and an online or offline printing device for printing, the system comprising an embedded apparatus capable of generating targets for calibrating and profiling a colored media using an inkset, white ink, and an offline or online printing device; the printing involving generation of white ink data and a corresponding separation for printing inkset for the target to be printed on the colored media, a dual-acting device capable of acting in a first aspect as a plate making or film generating means in respect of offline printing, and in a second aspect acting as a print controller in respect of online printing; and a printing device selected from a group comprising of devices like offset printing device and screen printing device when offline printing being adapted, and/or, selected from a group comprising of devices like inkjet printer and laser printer when online printing being resorted to, the embedded apparatus further being enabled to read the color values of the printed target and generate corresponding calibration data and/or color profile using the read values of the target.

In Second aspect of this invention there is provided a method of adapting the use of white ink to enable the use of a solid colored background as an ink participating in color formulation during the printing; adapting white ink in combination with black ink; and adapting white ink when both black ink and the background ink being laid down at same location on the media; and a method of adapting white ink to carry-out the steps of calibrating and profiling.

In third aspect of the invention there is provided a process of calibrating and profiling a colored media on a printer using an inkset and white ink adaptation, comprising the steps of determining an ink limit by generating a plurality of images by using a given inkset and white ink with several combinations of inks at different percentages including identification of the image with the highest combined ink percentage which does not bleed, puddle or feature; linearizing response of white ink on the colored media; linearizing or calibrating the printer response by printing targets with various percentages of individual inks and inputting the data to a measuring means to generate a linearization table; adapting the calibrating response of the printer and printing profiling target or patches of various known combination from the given inkset which forms the basis of the forward relationship between the ink values and the generated color; and reading the printed target by using the measuring means and generating the color profile based on this data using a ink model suitable to define the color reproduction for the printing process and inks used, the color profile providing the forward and backward relationship between the given color and the ink percentages.

In a fourth aspect of the invention there is provided an improved apparatus to generate a color separation for printing on colored background with white ink, the apparatus comprising an input means representing a printable image in the form of vector or bitmap being one of a color or grayscale, the image containing transparency data in explicit form or in implicit form as encoded with the image data; a first controller enabling automatic generation of a white underbase and suitable separations for colored inks; a second controller operable under dual mode, in a first mode acting as a plate-making or film-generating device when the printing being offline, and in a second mode acting as a print controller when the printing done on-line; and one of an offline and online printing device.

BRIEF DESCRIPTION OF THE ACCOMPANYING DRAWINGS

FIG. 1 shows an apparatus for profiling a colored media using white ink according to the present invention.

FIG. 2 shows a detail diagram of the input device of FIG. 1.

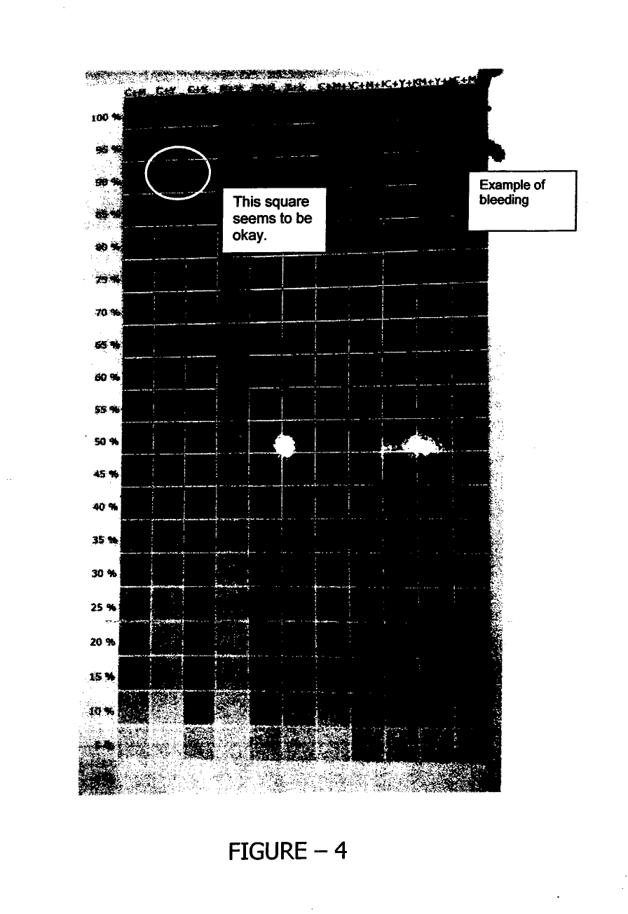

FIG. 3 shows a detail diagram of the output device of FIG. 1.

FIG. 4 shows an example of chart or ink limit target for determining ink limit during a process of calibration and profiling a white media.

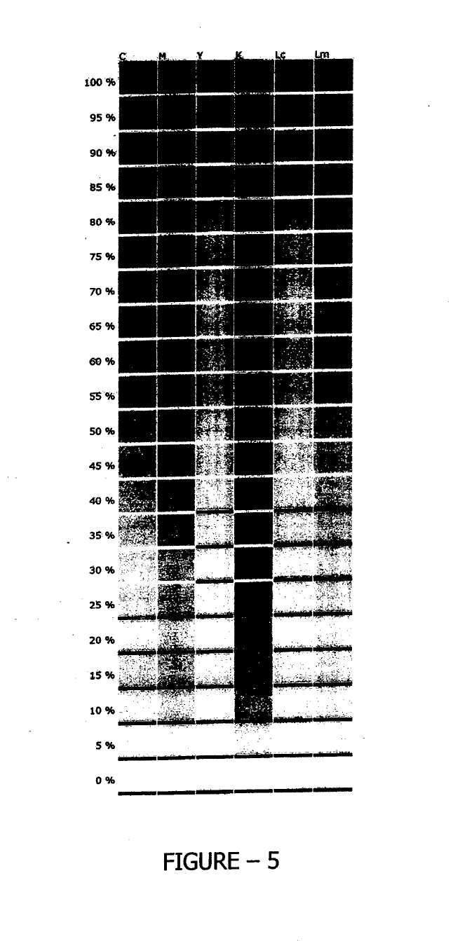

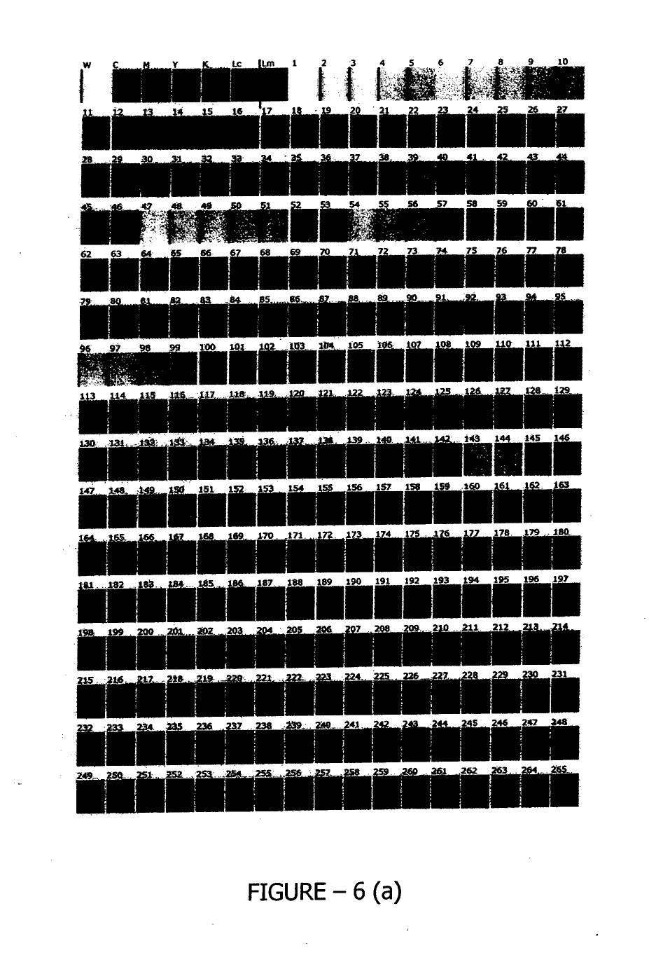

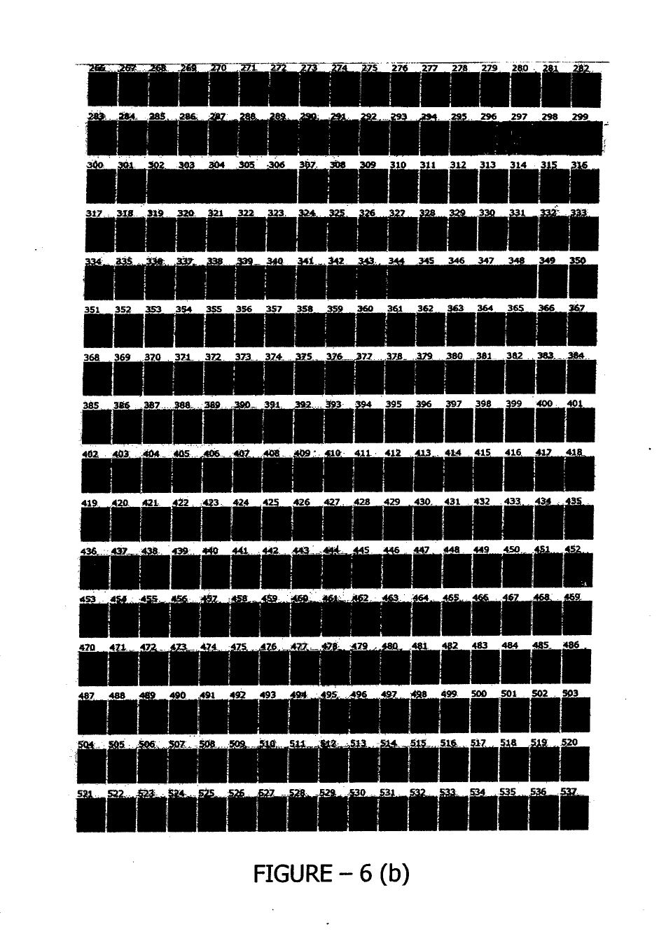

FIG. 5 shows an example of linearization chart or linearization target to calibrate a printer response in the process of calibration and profiling of a white media.

FIG. 6A and 6B shows respectively an example of a partial profiling target containing patches of known ink combinations for profiling the white media.

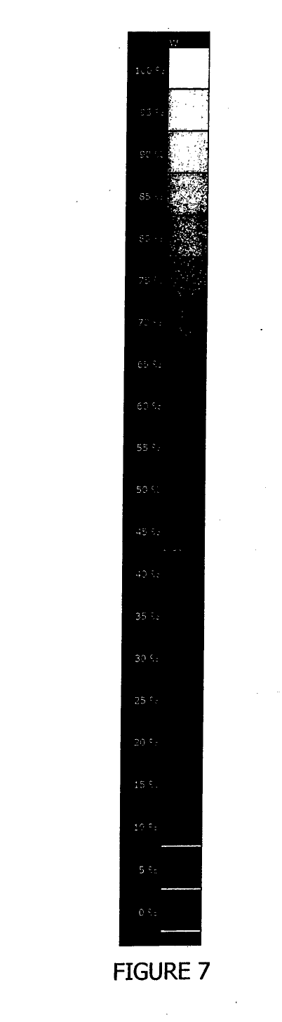

FIG. 7 shows an example of optional white linearization target printed on a colored media according to the process of invention.

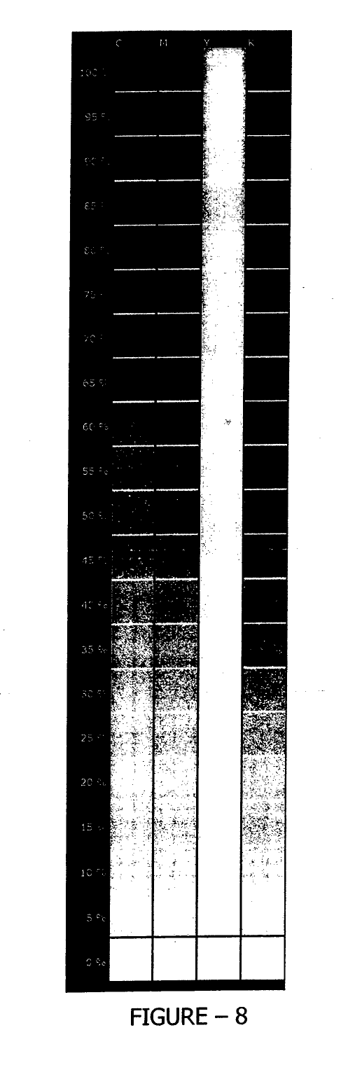

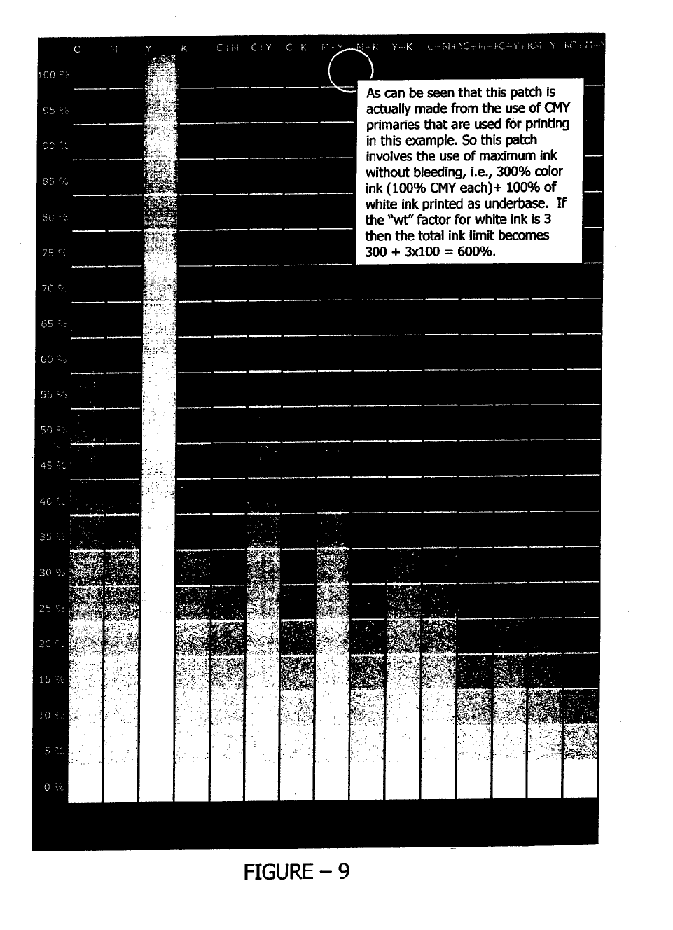

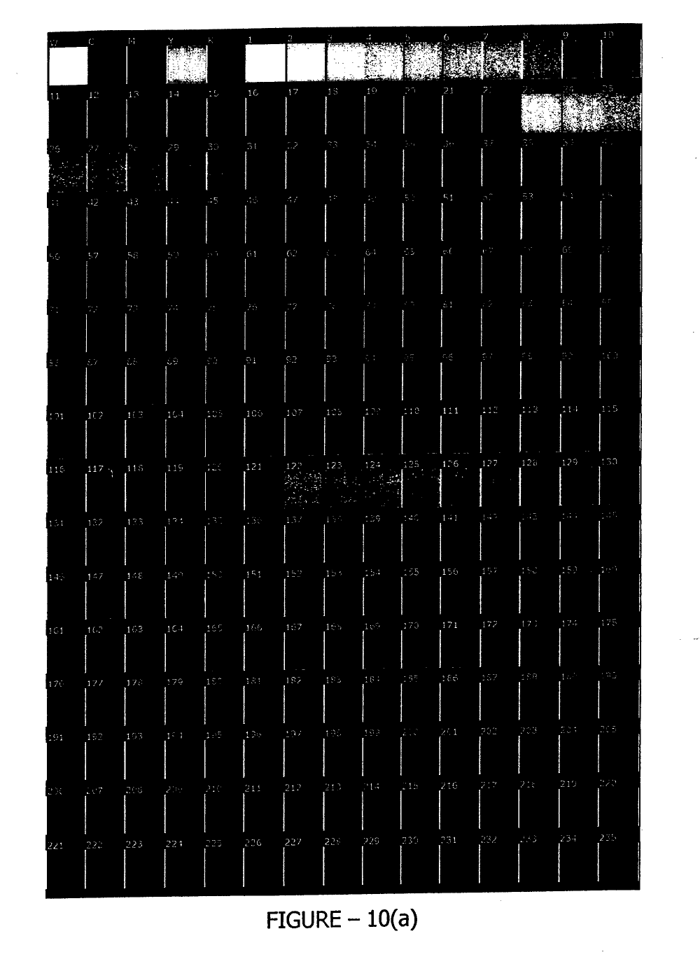

FIG. 8 shows an example of linearization target for the inkset printed on a colored media according to the invention.

FIG. 9 shows an example of ink limit chart or target printed on a colored media in accordance with the present invention.

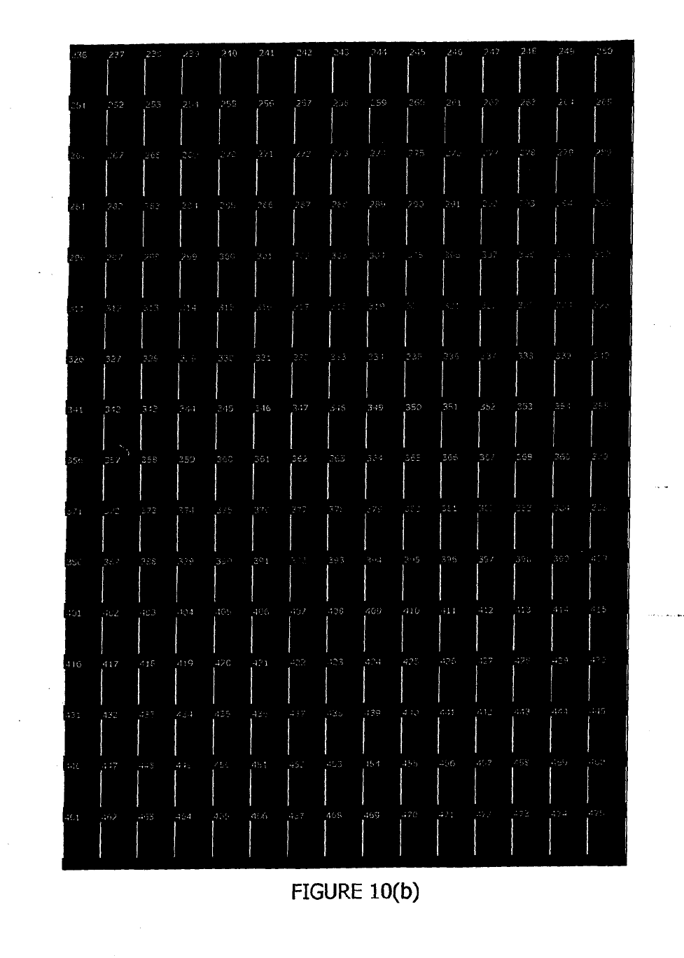

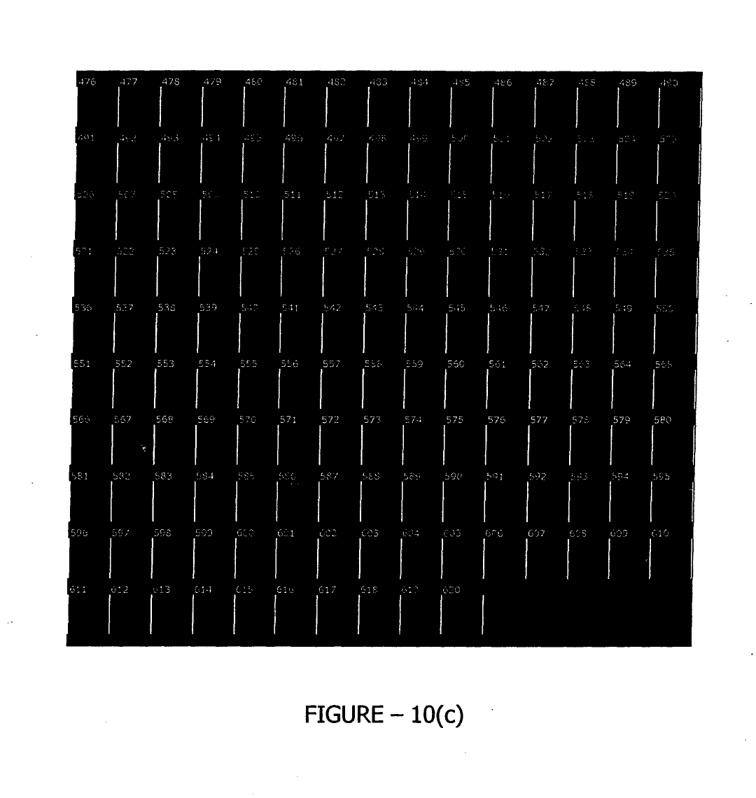

FIGS. 10A to 10C each shows an example of partial profiling target with known ink combinations printed on a colored media according to the invention for creation of color profiles.

FIG. 11 shows an improved apparatus to generate color separations for printing on a colored background using a white under base in accordance with the present invention.

### DETAILED DESCRIPTION OF THE INVENTION

According the present invention, and as shown in FIG. 1, the apparatus required for profiling the colored media using white ink comprises an input device (1), a controller (2), and an output device (3).

The patches generated by the printer (element of output device (3)) under the control of controller (2) are read by a color measurement device (7) and fed back to the controller (2) for linearization and profile generation.

Patches are generated on the input colored media using the printer during the various steps of the invention. In some cases as described hereinafter these patches are read by the color measuring device and fed back to the controller (2) for further processing.

As can be seen from FIG. 2, the Input device (1) is used by the controller (2) to produce the Output (3). Whereas,
1. The controller (2) of the subject invention constitutes a controlling device (2) controlling the whole apparatus involved in calibrating and profiling the colored media.
2. As shown in FIG. 2, the input device (1) comprises:
a substrate (4) having any color other than white;
White ink (5) to be used in printing. White ink is the special ink that can be defined as any chemical or pigment based ink that can result in appearance of white on a colored background either solo or in combination of other chemicals and/or process. For example Discharge ink, TiO2 pigment based ink, white powder based toners etc.
Regular color inks (6) that are to be used in printing. For example Cyan, Magenta, Yellow, Black, Blue, Light cyan, Light Black ink etc. Together in various combinations these inks are referred to as inkset in this invention.
Color Measurement device (7) used to measure the color value of the patches printed on the colored media using the printer by unit 1. Such color measuring devices can include but not limiting to spectrophotometer, colorimeter, scanner, digital camera etc.
3. As shown in FIG. 3, the output device (3) comprises:
a printing device (8) that can be either online or offline capable of printing using the given inkset;
Output Patches (9) generated in the form of printed patches on the printer (8) under the control of the controller (2) at various stages of the process of calibration and profiling, depending upon the stage, the output patches (9) being interpretable by the user of the system to determine the ink limit or capable of being read by the color measuring device (7) for feeding back to the controller (2) for of calibrating and profiling; and
A linearization table and color profile (10). These are the expected output of the result of carrying out the invention.

The process of calibrating and profiling a white media using an inkset on a printer, involves the following steps
1. Determining the ink limit,
2. Linearization or calibration of printer response,
3. Target printing for profiling, and
4. Measuring a of target and Profile generation.

### 1. Determining the Ink Limit

“Ink Limit” is the maximum capacity of the printing media to hold the ink without resulting into spreading or puddle. It is the function of dyestuff or pigment and the amount of solvent in the ink.

Usually for determining ink limit squares of various combinations of inks at different percentages are printed on the printer using the given inkset. Ink limit is determined by locating the square with the highest combined ink % that does not bleed, puddle or feather. This combined % becomes the ink limit. There can be several different types of such charts to determine the ink limit. As an example one such chart is shown in FIG. 4.

### 2. Linearization or Calibration of Printer Response.

This involves printing the various % of individual inks graduating between 0 to 100% on the printer using the given inkset. These individual ink bars are read by the spectrophotometer or any other color measuring device and the linearization curves for these individual inks are created. As an example of such linearization chart see FIG. 5.

### 3. Target Printing for Profiling.

This involves using the calibrated response of the printer to print the patches of various known ink combinations from the given inkset. See FIGS. 6(a) and 6(b).

The target forms the basis of the forward relationship between ink values and the generated color. This target is used by the “ink model” to define the relationship between the ink values and the resulting color using the process of printing.

### 4. Measurement of Target and Profile Generation.

The target thus printed as in step 3 is then read by the spectrophotometer or any other color measuring device. On the basis of this data the color profile is generated. The color profile usually defines the forward relationship between the given ink percentages and the resulting color based on it as well as the backward relationship between the given color and the ink percentages required to achieve it. See reference[9].

During the process of calibration and profiling the white media using an inkset on a printer as described herein above, target patches needs to be generated based upon the “ink model” implemented by the calibrating and profiling unit. The ink model defines the theoretical or analytical model which is used to interpret the ink behavior or response on the media. These can be implemented completely independent of the process described in the preceding paragraphs. The only bearing the choice of such ink model will have will be on the actual patches that are generated. The steps of the process will however will remain same as outlined above.

The creation of color profiles may also involve providing mapping for colors that cannot be achieved by any combination of the inks or color gamut defined by the inks in the printing inkset. This process is called “Gamut mapping”. See references [4][5][6][9]. Different strategies can be implemented for gamut mapping. However this again is independent of the process as outlined above without having any bearing on it. For example different gamut mapping technique may define how a particular “Blue” color outside of the color gamut of the inkset be mapped on to the gamut of the inkset, but will not change any step of the procedure outlined above. See [4][5][6].

### Process of Calibrating and Profiling Colored Media Using White Ink

The process of calibrating and profiling the colored media using white ink and the regular inkset remains same as for white media except for the fact that each step must be adapted for use with white ink. It also involves an additional optional step of calibrating the white ink response on the colored media.

As noted earlier key objective of this invention is to use the solid colored background as an ink participating in color formation during printing as would be the case with normal ink.

Also another objective of this invention is to adapt the use of white ink with black color, if it is used in the inkset for printing and the solid colored background is not same as the black color. Hence, in order to carry out the objective of calibration and profiling colored media using white ink, following methods are defined as per the invention
a. Method to enable the use of solid colored background as an ink participating in color formulation during printing as would be the case with normal ink. Henceforth this will be termed as “background ink”.
b. Method to adapt the use of white ink with Black ink.
c. Method to adapt the use of white ink when both Black ink and the Background ink are laid down at the same place.
d. Method to adapt the use of white ink to carry out the process of calibration and profiling.
e. Process for calibration and profiling.
   a. Method to Enable Use of Colored Background as an Ink.

In order to be able to use the colored background as an ink the background color must be modulated between the background color and the white color using white ink. This can be achieved by applying white ink in % varying from 0 to 100%. The % of “background ink” can be related to the % of white ink to be applied by the following equation

Background ink %=(100−white ink) %. equation (1)

Thus, if 100% of Background ink is to be applied then the white ink % to be applied is 0%. Similarly for 50% of background ink, the white ink applied over the background is 50% and for 75% of background ink 25% of white ink is applied over the background.

According to the invention, the inkset can now have “background ink” in addition to regular inks by implementing this method.

b. Method to Adapt The Use of White Ink With Black Ink.

The key purpose here is to reduce the amount of white ink to be used when black ink is printed. The key idea here is that Black color when printed over any color is still almost black. So, as the amount of Black color applied on the media is reduced, the amount of white ink applied is increased. The % of “Black ink” can be related to the % of white ink to be applied by the following equation

White ink %=K×(100−Black ink)%+Const. equation (2)

### Where,

“K” is the weight, that can assume a real number.
“Const” can be a value between 0 to 100%
And, the value of “White ink” so computed is bounded between the range 0 to 100%.

“Const” value is sometimes desired to get more depth of black based upon the chemistry for printing involved. “K” is usually 1.

So as per equation (2), assuming value of “Const” to be 0% and “K” is considered as 1, when Black color % to be applied is 100%, white ink applied is 0% and when 50% black is applied then 50% white ink is applied. Similarly, when 0% Black ink is applied 100% white ink is applied.

c. Method to Adapt the use of White Ink When Both Black Ink and the Background Ink are Laid Down at the Same Place.

At a point in the image when both the “Background ink” and the “Black ink” is to be applied, in that case the white ink amount to be applied is determined based on the “Background ink”.

Let W1 be the percentage of white ink to be applied based on the percentage of “Background ink” as determined by rearranging equation (1).

So Let W2 be the white ink percentage to be applied at that place. The value of W1 is assigned to W2. Mathematically,

W2=W1=(100−Background ink) %. equation (3)

As can be seen equation (3) can be applied by rearranging equation (1), so mathematically they are same.

Thus, if at a point 50% orange and 75% Black is to be applied, then as per equation (3) 50% white ink applied. If at a point 10% orange and 45% Black is to be applied, then as per equation (3) 90% white ink is applied.

Method (b) and (c) optimizes the use of white ink.

d. Method to Adapt the Use of White Ink To Carry Out the Process of Calibration and Profiling.

If the regular inks from the given inkset are printed naively on the colored media, the print will result in unexpected. Say if the colored background is black, hardly any color will be visible. So printing of regular inks on the colored background must involve use of white ink.

Based on the methods (a), (b) and (c) outlining adaptation and optimization of white ink, we can have 3 cases of adaptation/optimization of white ink use as under
1. Adaptation in use of white ink performed only with use of “Background ink” irrespective of black ink being used or not.
2. Optimization in use of white ink is performed with use of “Black ink” present in the inkset and no “Background ink” is used.
3. Both “Background ink” and “Black ink” is used for printing. Optimization/adapation in use of white ink is performed for both “Black ink” and “Background ink”.

Based upon the adapted/optimized use of white ink as explained hereinabove, the disclosure herein shall refer to “Background ink” and “Black ink” as “optimized ink” whether being used together or used individually or used alone without one another.

Thus in order to print the regular inks from the inkset being used for printing on the colored background, the white ink amount to be printed as an underbase requires a consideration. Wherever there is no “optimized ink” involved in ink combination 100% patch of white ink is laid down. The instances where there is use of of the “optimized ink” correct percentage of white ink is computed based upon any one of the equation from equation(1), equation (2) or equation (3). The choice of the equation is dependent upon if only “Background ink” is involved or only “Black ink” is involved or both are involved at the point.

In terms of steps, white ink percentage to be used is determined as under

### Procedure 1

Step 1—Does the ink combination to be printed involves “optimized ink”? If yes then go to step 2, else go to step 8.
Step 2—Does the ink combination to be printed involve use of only “Background ink”? If the answer is yes then go to step 3 else go to step 4.
Step 3—The white ink percentage is as determined from equation (1). Go to Step 9.
Step 4—Does the ink combination to be printed involve use of only “Black ink”? If the answer is yes then go to step 5 else go to step 6.
Step 5—The white ink percentage is as determined from equation (2). Go to Step 9.
Step 6—Does the ink combination to be printed involve use of both “Black ink” and “Background ink”? If the answer is yes then go to step 7 else go to step 8.
Step 7—The white ink percentage is as determined from equation (3). Go to Step 9.
Step 8—The white ink percentage is 100%.
Step 9—End of steps.

The white ink percentage to be used is determined as per the steps above based upon the ink combination to be printed. White ink can be printing based upon the printing method-deployed for printing.

Say if the printer is using the primaries as CMYK and the background color is Orange, thus the Background ink is orange ink created with the help of graduating white ink on the background.

Now for example if X% C of CMYK primaries is to be printed, then as per the steps outlined above 100% white ink and X% of C will be printed.

As another example, if X% of C and Y% of Orange ink is to be printed then as per steps outlined above (100−Y) % of white ink and X% of C will be printed.

Yet another example, if X% of C and Y% of Black ink is to be printed and “Black ink” is used as optimized ink then as per steps outlined above (100−Y) % of white ink, Y% of Black ink and X% of C will be printed.

Yet another example, if X% of C, Y% of Orange ink and Z% of Black ink is to be printed and “Black ink” is used as optimized ink then as per steps outlined above (100−Y) % of white ink, Z% of Black ink and X% of C will be printed.

Yet another example, if X% of C and Y% of Black ink is to be printed and “Black ink” is not used as optimized ink then as per steps outlined above 100% of white ink, Y% of Black ink and X% of C will be printed.

Yet another example, if X% of C, Y% of Orange ink and Z% of Black ink is to be printed and “Black ink” is not used as optimized ink then as per steps outlined above (100−Y) % of white ink, Z% of Black ink and X% of C will be printed.

e. Process for Calibration and Profiling.

The process for calibrating and profiling the colored media using white ink and the regular inkset on a printer, comprises the steps of
1. White ink linearization. (Optional step)
2. Determining ink limit. (For whole ink set including background ink)
3. Linearization or calibration of printer response. (For whole ink set including background ink)
4. Target printing for profiling.
5. Measurement of target and Profile generation.

### 1. White Ink Linearization.

This step is optional and thus can be ignored if desired. The white ink response on background media can be linearized first before being used in the process of calibration and profile generation. Linearization of the white ink application on the background color is recommended but not necessary. This step is anyways covered by linearization of the background ink along with other regular inks of the inkset used for printing.

### 2. Determine Ink Limit.

Ink limit for printing with white ink on colored media can be found out much in the same way as with printing on white media except for the adaptation required for the use of amount of white ink.

Some printing methods like an inkjet process use multiple channels/multiple arrays of nozzles/multiple print-heads of white ink to achieve appropriate whiteness. This will result in more ink amount being used in comparison to other colors inks on a scale of 0 to 100%. Also different resolutions could be used to print white ink and the color inks that would result in different amounts of ink being used on an absolute scale corresponding to individual percentages. So in such cases the % of white ink is weighted by a weighing factor to bring the % in absolute terms at par with the color ink amount.

The weighting factor is determined by the following equation

Weighting factor, “WF”=(Ink amount by weight used to print 100% patch of white ink)/(Ink amount by weight used to print 100% patch of any regular color ink). equation (4)

This weighting factor “WF” can be determined automatically by the controller (2) if ink amount information as required by equation (4) is available to it or it can be determined by the end user of the system and fed to the controller (2).

For example, consider an inkjet printing machine used for printing. Printing is done as 2 step process, where white ink is printed first on the colored media and colored inks are printed in the second step on top of the white ink. The white layer is printed at 1440×720 DPI (X by Y direction) using a 40 pl (picoliter) drop and 3 channels. The color layer is printed at 720×720 DPI (X by Y direction) using 20 pl drop and one channel for each regular ink in the inkset. Here DPI is Dot per inch and one picoliter is equal to 10⁻¹² liter.

So the ink amount used for 100% patch (finch×finch) of white ink is computed as (1440×720)×40×3 pl. Similarly the ink amount used for 100% (cinch×finch) patch of regular ink is computed as (720×720)×20×1 pl. The “WF” thus can be computed as—((1440×720)×40×3)/((720×720)×20×1)=12.

Here in the computation above we have assumed the density of the white ink and the regular ink to be same and hence only volume was used in computation.

Following steps are used to determine the total ink limit or TIL from the test pattern printed in accordance with Method (d) described on the previous pages.

### Procedure 2

Step 1—Find the color patch having maximum amount of ink with no puddle, bleed or feather.
Step 2—Determine the % of color ink used for this patch. Let this be “TC”.
Step 3—Determine the amount of white ink printed for this patch as per steps of Method (d). Let this be “TW”.
Step 4—The total ink limit “TIL”, which is equivalent to amount of ink used to print the patch can be determined by using the following equation

Total ink(%)=WF*TW+TC. equation (5)

Now for example, consider a case involving printing of white ink using 3 channels on an inkjet printer. It is found that a 3 ink combination not involving any of “optimized ink” is representing the total ink limit to be used. The combination of regular color ink for this patch is say 150%. So the total ink limit will thus be 150%+total % of white ink. Assuming the weighting factor of 3 in this case the white ink limit works out to be 3*100%. So the total ink limit (TIL) works out to be 150%+300%=450%.

Thus, the ink limit so determined is to be used in the generation of patches to be used for Linearization and target for profiling. The amount of ink used for every patch being generated for printing can be computed in accordance with equation (5).

White ink can be printed either as underbase over which colors are printed or can be printed at the same time as color inks or by any other way.

Further, Ink limit can be determined by any set of test chart. In our case we prefer to print the blocks using the combination of inks including background ink varying between 0 to 100% in steps of 5%. We identify the block having total ink volume above which the ink starts to spread or puddle. This becomes the ink limit.

The process for computing the amount of white ink involved in printing by using a weight factor and subsequently computing the total ink limit involved as described hereinabove, may further be used to determine the total ink limit for inksets that may or may not be involving use of white ink, but are using some other inks in more proportion than the rest of colors of the inkset. For example—consider a printing system involving 2 channels of Cyan, 2 Channels of Magenta and one channel of Yellow and Black each. The weighting factor can be individually applied to both Cyan and Magenta just like in case of white ink and total ink limit can be computed by adding the weighted sum of Cyan and Magenta ink to that of Yellow and Black.

Further the step of using the using the weight factor in computing the total ink can be extended to situations where although same number of channels are used for printing but different volume of ink is being used for each individual color. For example in an inkjet printing system, assume black color in the CMYK inkset is using 40 pl drop size and rest of the colors are using the 20 pl drop size. Assuming the printing to be done at the same resolution and the inks are of same density, the weight factor “WF” for black ink can be computed as per equation (4) to be 40/20=2.

Similarly this concept can be extended to situations where the number of channels used for printing one or more color channel is more than the others. This would again result in different amount of ink being applied for this color using more channels than the others. For example in an inkjet printing system, assume black color in the CMYK inkset is using 20 pl drop size but 2 channels for printing and rest of the colors are using the 20 pl drop size and one channel each for printing. Assuming the printing to be done at the same resolution and the inks are of same density, the weight factor “WF” for black ink can be computed as per equation (4) to be (20×2)/20=2.

It can also be applied to cases where there is difference in ink limit arising out of different combination of inks, for example, in case of CMYK inkset CMK and CYK having different ink limits. The difference could be because of difference in pigment loading of M and Y leading to the difference in densities of the two inks. So the differences can be brought to the same absolute scale by computing proper weight factor for the ink having higher density.

### 3. Linearization or Calibration of Printer Response.

Calibration by definition is the process to get the device to get into a known state of response. Linearization achieves this goal. The process of linearization involves printing of the single color ramp of individual inks including background ink ranging from 0% to 100% (or any other ink % depending upon the intent). These patches can be printed in accordance with Method (d). Linearization process can be ignored too depending upon the ink model used for profiling. Whatever the ink model in use it does not have any impact on the teachings of the invention.

The linearization patches thus produced are measured using a color measuring device (7) and fed to the controller (2) for generation of linearization table.

### 4. Target Printing for Profiling.

The last step is to produce the target for profiling. The patches in this target are printed in accordance with Method (d).

The patches with the ink amount above the ink limit can either be ignored at the time of printing or ink combinations exceeding the ink limit can be ignored during profile creation. Whatever the approach it does not have impact on the teachings of this invention.

The steps of the determining ink limit, linearization and the profiling can be practiced with any ink model or target depending upon the suitability to the end use. This however does not have any effect on the teachings of this invention.

### 5. Measurement of Target and Profile Generation.

The target produced during step 4 above is measured using a color measuring device (7) and fed to the controller (2) for generation of color profile.

Profiling involves creation of color profiles for a given set of inks, media and print mode from the known set of ink values. The color profile is in general the color lookup table or any other suitable function/representation that is used to transform the color values from input color space to the output color space. For example, the input color space can be CIE L*a*b* color space and the output color space can be the device color space like CMYK or more particularly in the context of this invention an inkset+background ink like CMYK+background ink or CMY+black background ink etc.

The methods taught by this invention can be practiced with any specific method of choice for linearization and color profile generation without loosing their applicability in general. It will be recognizable to the person skilled in art that modifications to the teachings of this invention can be practiced to achieve the same result as the invention. Such modifications are also covered under the scope of this invention.

FIGS. 7-10 shows various targets printed using the methods of the invention. These targets are printed on a Black background with the Black color of the background being used as “background ink” along with the use of CMY inkset and the white ink for printing.

FIG. 7 shows the example of optional white linearization target printed according to the invention.

FIG. 8 shows the example of Linearization target printed according to the invention.

FIG. 9 shows the example of Ink limit test printed in accordance with the method of the invention.

FIGS. 10(a), 10(b) and 10(c) shows the example target for profiling printed according to the invention.

The first aspect of the invention for example, calibrating and profiling colored media using an inkset and white ink, warrants an improvement to the known method of generating white underbase for colored backgrounds.

Reference [10] suggest that a huge savings can be achieved in respect of the white ink when printing on Black background by treating the color of black background as an ink participating in the printing process.

As disclosed in reference [10], the present invention in a fourth aspect adapts the same known apparatus for printing. However the controller of the cited invention has been further modified according to the invention to achieve an improvement to printing on colored backgrounds other than white.

As shown in FIG. 11, illustrates an improved apparatus to generate a color separation for printing on color background with white ink. The apparatus comprising:
a. Input means (11) represents the image that is to be printed on the colored background. This image can be color or grayscale. The image (11) can be vector or bitmap in nature. The image (11) may also contain transparency information. The transparency information is the information that indicates how opaque the image is at a particular location. Popular image editing software embeds this information as a part of the image. Adobe Photoshop from Adobe Corporation for example embeds this information with the color data as a layer. This transparency information is generally generated by the designer of the image as a part of his artwork design.

The transparency information can also be encoded with the image data in other ways for example as a special color which is not the part of the image data. Such encoding is permitted by file formats like PNG or GIF. The purpose of highlighting different ways of encoding the transparency information with the image data is to illustrate different means of encoding the transparency information along with the image data.

Another term that is used very often in place of transparency is opacity. In fact Opacity and Transparency are duals of each other and related by a simple equation of Transparency %=100%−Opacity%. Hence throughout this invention the transparency and opacity are the words used as deemed appropriate to illustrate and are related to each other by the preceding equation.
b. The first controller (21) allows implementation of an improved method of printing over colored background other than white using white ink and printing inkset of colored inks. The first controller (21) enables automatic generation of white underbase to be used with the colored inks to achieve the improvements over reference [10]. This is explained in more detail later.
c. The second controller (31) constitutes a plate making device or film generating device if the printing is to be done offline. If the printing is to be done online then this device is the print controller that receives the instruction on the basis of the white underbase data and the colored ink data generated by the first controller (21). This reception of information can be instant for an online printing device as it is being generated by the first controller (21) or can be stored and transmitted later to it.
d. Offline and Online printing devices (41) are explained earlier in the invention. For examples, Offline printing devices includes printing or screen printing machines etc. Online printing devices include devices like inkjet printer, laser printer etc.

There are 2 major use cases for which the first controller (21) is to be adapted. These are outlined below
Use Case 1—Background color is treated as “Background ink”
Use Case 2—Background color is not treated as “Background ink” but “Black color” is treated as “optimized ink” as explained above in Method (d) of “Process of calibrating and profiling colored media using white ink”.

Use case 1 can have further 2 considerations

Consideration 1—where Black ink is treated as “optimized ink” as explained above in Method (d) of “Process of calibrating and profiling colored media using white ink”.

Consideration 2—where Black ink is not treated as “optimized ink” as explained above in Method (d) of “Process of calibrating and profiling colored media using white ink”.

In order to be able to utilize the first controller (21) for both the above mentioned use cases, it is necessary to determine the equivalent of value of background color in the Image source color space.

### Method to Determine the Equivalent of Value of Background Color in the Image Source Color Space.

Each Image to be printed has its own colorspace that defines how to interpret the colors in it. See reference[8][9]. Using the color table generated as part of outcome of step (5) “Measurement of target and profile generation” of “process of calibrating and Profiling colored media using white ink” hereinabove, the color value of the background in terms of image color space is determined. This can be done by setting the value of “Background ink” as 100% and rest of the inks in the inkset as 0%. Then through a reverse transformation from the printing inkset colorspace to the image colorspace value of background ink in terms of image color space is determined. Such transformations are very well defined in the literature [8][9].

When the background color lies outside of the image colorspace then color values from the image colorspace are transformed to a “third colorspace” that contains whole of the image colorspace and the value of background color. The values thus represented in this third colorspace are linked through appropriate transformation to printer inkset colorspace.

This image colorspace or the third colorspace to which the input image colorspace is linked through a transformation to accommodate the background color is termed as “Input colorspace”. The printer inkset colorspace is termed as “Output colorspace”. Input colorspace is linked to output colorspace through appropriate transformations.

The images are usually represented as rectangular grids of can have variable transparency.

### Implementation of Use Case 1

### Procedure 3

Step 1—Determine if the opacity of the image at the point to be printed is zero. If yes, the assign the value for white underbase as “W’=0% and all printing primaries in “P” as 0%. Go to step 12, else go to step 2.
Step 2—Determine the equivalent value for the 100% “background ink” in input colorspace as defined by the “method to determine the equivalent of value of background color in the Image source color space” above. Let us call it “BC”.
Step 3—Determine the final color to be separated by composing the color “C” of the image using its “Opacity” information with the background color BC as determined in Step 2. The following equation is to be used, Resulting color “R”=(((100−Opacity))×BC+Opacity×C)/100.
Step 4—Determine the printer primaries by transforming the color “R” from the input color space to the output color space representing the printing primaries “P”.
Step 5—If Black ink is used as optimized ink then go to step 6 else go to step 9.
Step 6—If “P” contains 0% for Background color and 0% for “Black color” then assign the value of the white ink “W” as 100% and go to Step 12, else go to Step 7.
Step 7—If the “Background ink” value is not 0% then assign the white ink “W”=(100−Background ink)%. Go to step 11, else go to step 8.
Step 8—Assign the white ink “W”=K**×(100−Black ink)+Const* %. The value of “W” is bounded to the range between 0 to 100%. Go to Step 12.
Step 9—If “P” contains 0% for Background color then assign the value of the white ink “W” as 100% and go to Step 12, else go to Step 10.
Step 10—Assign the white ink “W”=(100−Background ink) %.
Step 11—Assign the “Background ink” value of 0%.
Step 12—We now have the value of printing ink primaries as well as the value of white ink to be printed. This value of white ink can be then used to print the correct amount appropriately based upon the printing process, e.g., using 3 channels etc.
   * “Const” can be a value between 0 to 100%.
   ** “K” can assume any real number based upon needs, usually 1.

### ILLUSTRATIVE EXAMPLES

Consider the background color “Orange” having the value in input space defined as “BC”=RGB (255, 85, 0), where RGB is the input space.
Inkset/Printer primaries CMYKO where 0 is “background ink” “Orange”.
Value of “Const” assumed to be 0.
Value of “K” assumed to be 1.

### Example 1

Considering Red Color Defined as “C”(R,G,B)=(255,0,0) and opacity 100%.

Carrying out the steps of “Procedure 3”, as described earlier, the following outcome is observed:
Step 1—Non zero opacity, the color “C” is considered for processing.
Step 2—Background color “BC”=RGB(255, 85, 0).
Step 3—Computing color “R” from “C” and opacity as R=(((100−100)×(255, 85, 0))+(100×(255,0,0)))/100 to get “R”=RGB(255,0,0).
Step 4-Step 12—Executing steps 4 till step 12 as appropriate, White ink value “W” is computed as 10% and printer primaries “P” as CMYKO (0, 80, 0, 0, 0)

Example 2

### Considering Red Color Defined as “C”(R,G,B)=(255,0,0) and Opacity 0%.

Carrying-out the steps of “Procedure 3”, the following outcome is observed:
Step 1—zero opacity, so assigning the value of 0% to white underbase “W” at that point and printer primaries “P” as CMYKO (0, 0, 0, 0, 0).

### Example 3

Considering Red Color Defined as “C”(R,G,B)=(255,0,0) and opacity 70%.

Carrying-out the steps of “Procedure 3”, the following outcome is observed:
Step 1—Non zero opacity, the color “C” is considered for processing.
Step 2—Background color “BC”=RGB(255, 85, 0).
Step 3—Computing color “R” from “C” and opacity as R=(((100−70)×(255, 85, 0))+(70×(255,0,0)))/100 to get “R”=RGB(255,25.5,0).
Step 4-Step 12—Executing steps 4 till step 12 as appropriate, White ink value “W” is computed as 5% and printer primaries “P” as CMYKO (0, 65, 0, 0, 0)

### Example 4

Considering Dark Red Color Defined as “C”(R,G,B)=(140,33,37) and opacity 100%.

Carrying-out the steps of embodiment 1, the following outcome is observed:
Step 1—Non zero opacity, the color “C” is considered for processing.
Step 2—Background color “BC”=RGB(255, 85, 0).
Step 3—Computing color “R” from “C” and opacity as R=(((100−100)×(255, 85, 0))+(100×(140,33,37)))/100 to get “R”=RGB(140,33,37).
Step 4-Step 12—Executing steps 4 till step 12 as appropriate, White ink value “W” is computed as 50% and printer primaries “P” as CMYKO (24, 32, 24, 21, 0)

Implementation of Use Case 2

### Procedure 4

Step 1—Determine if the opacity of the image at the point to be printed is zero. If yes, the assign the value for white underbase as “W’=0% and all printing primaries in “P” as 0%. Go to step 5, else go to step 2.
Step 2—Determine the final color to be separated by composing the color “C” of the image using its “Opacity” information with white color “WC” using the following equation, Resulting color “R”=(((100−Opacity))×WC+Opacity×C)/100, where “WC” is the color of the white defined in the input color space.
Step 3—Determine the printer primaries by transforming the color “R” from the input color space to the output color space representing the printing primaries “P”.
Step 4—Compute the white ink percentage “TW” on the basis of “Black ink”. “TW”=K**×(100−Black ink)+Const* %. The value of “TW” is bounded to the range between 0 to 100%. Now compute the value of final white ink percentage to use “W”=((Opacity×TW)/100) %.
Step 5—We now have the value of printing ink primaries “P” as well as the value of white ink “W” to be printed. This value of white ink can be then used to print the correct amount appropriately based upon the printing process, e.g., using 3 channels etc.
   *“Const” can be a value between 0 to 100%.
   **“K” can assume any real number based upon needs, usually 1.

### ILLUSTRATIVE EXAMPLES

Inkset/Printer primaries CMYK.
Input color space RGB. In case of RGB input color space the white color “WC” is represented by RGB (255,255,255).
Value of “Const” assumed to be 0.
Value of “K” assumed to be 1.

### Example 1

Considering Red color defined as “C”(R,G,B)=(255,0,0) and opacity 100%.

Carrying-out the steps of “Procedure 4”, the following outcome is observed.
Step 1—Non zero opacity, the color “C” is considered for processing.
Step 2—Computing color “R” from “C” and opacity as R=((100-100)×(255,255,255)+100×(255,0,0))/100 to get “R” =RGB(255,0,0).
Step 3-Step 5—Executing steps 3 till step 5 as appropriate, White ink value “W” is computed as 100% and printer primaries “P” as CMYK (0,99,100,0).

### Example 2

Considering Red color defined as “C”(R,G,B)=(255,0,0) and opacity 0%.

Carrying-out the steps of “Procedure 4”, the following outcome is observed:
Step 1—zero opacity, so assigning the value of 0% to white underbase “W” at that point and printer primaries “P” as CMYK (0, 0, 0, 0).

### Example 3

Considering Red color defined as “C”(R,G,B)=(255,0,0) and opacity 50%.

Carrying-out the steps of “Procedure 4”, the following outcome is observed:
Step 1—Non zero opacity, the color “C” is considered for processing.
Step 2—Computing color “R” from “C” and opacity as R=((100−50)×(255,255,255)+50×(255,0,0))/100 to get “R”=RGB(255,127.5,127.5).
Step 3-Step 5—Executing steps 3 till step 5 as appropriate, White ink value “W” is computed as 50% and printer primaries “P” as CMYK (0,64,39,0).

### Example 4

Considering Dark Green Color Defined as “C”(R,G,B)=(0,104,34) and opacity 100%.

Carrying-out the steps of “Procedure 4”, the following outcome is observed:
Step 1—Non zero opacity, so the color “C” is considered for processing.
Step 2—Computing color “R” from “C” and opacity as R=((100-100)×(255,255,255)+100×(0,104,34))/100 to get “R” =RGB(0,104,34).
Step 3-Step 5—Executing steps 3 till step 5 as appropriate, White ink value “W” is computed as 74% and printer primaries “P” as CMYK (89,33,100,26).

### Implementation

Such a system (both parts of the invention) can be implemented as an embedded system inside any printing device or a color measuring device with a microprocessor or with computing ability or using a computing device or a PDA. The preferred method of implementation is a computer system that can be interfaced with the devices mentioned as Input (1) and Output (3) block in FIG. 1 and Input (11) and controller 2 (31) of FIG. 11 or work in isolation and interfaced with Input (1) and Output (3) block in FIG. 1 and controller 2 (31) of FIG. 11 by means of data storage or data transmitting devices.

### CITED REFERENCES

1. “Reproducing color images as Duotones”.—Joanna L. Power et al., Page 237-248 in Conference proceedings of SIGGRPAH, Year 1996.
2. XRite Profile maker version 5. Website www.xrite.com
3. XRite Moncao profiler platimum edition. Website www.xrite.com
4. CIE Division 8: TC8-03 on Gamut mapping. Website http://www.colour.org/tc8-03/5.
5. Morovi\check{}c, J., To Develop a Universal Gamut Mapping Algorithm, PhD thesis, Colour & Imaging Institute, University of Derby (1998).
6. Morovi\check{}c, J. and Luo, M. R., “The fundamentals of gamut mapping: A survey,” Journal of Imaging Science and Technology 45(3), 283-290 (2001).
7. Encyclopedia of Graphics file formats (Second Edition)—Book by James D. Murray and William VanRyper, published by O'Reilly & Associates Inc.
8. Color Technology for Electronic Imaging Devices—Book by Henry R. Kang, published by SPIE Press. ISBN 0-8194-2108-1
9. ICC file format for color profiles—International color consortium website www.color.org .
10. Patent application (WO/2007/099554)—METHOD AND APPARATUS FOR GENERATING WHITE UNDERBASE AND GENERATING SUITABLY MODIFIED SEPARATIONS FOR PRINTING ON COLORED BACKGROUND OTHER THAN WHITE.

1-25. (canceled)

26. An embedded system for calibrating and profiling a colored media using an inkset, white ink and an online or offline printing device for printing, the system comprising:
(a) an embedded apparatus capable of generating, adapting and printing targets required for calibrating and profiling the colored media using an inkset, white ink and an offline or online printing device; wherein printing involves generation of white ink data and suitable separations for printing inkset for the target to be printed on the colored media;
(b) a dual-acting device capable of acting in a first aspect as a plate making or film generating means in respect of offline printing, and in a second aspect acting as a print controller in respect of online printing; and
(c) a printing device selected from a group comprising an offset printing device and a screen printing device when offline printing is used, selected from a group comprising an inkjet printer and a laser printer when online printing is used, and one printing device from each group when both offline and online printing are used.

27. The system of claim 26, wherein the embedded apparatus is enabled to read the targets and generate calibration data, color profiles, or both, using the read values of the target.

28. The system of claim 26, wherein the system allows the colored media adapted by white ink to participate as a background ink in the process of printing, the adaptation being defined by the relationship: background ink %=(100−white ink)%.

29. The system of claim 26, wherein the colored media is adapted to be used as an ink in the printing process.

30. The system of claim 26, wherein when printing black ink over a colored media, the useable quantum of white ink is determined by the relationship: white ink%=K×(100−black ink)%+Const, wherein “K” is a weight that can assume any real number, “Const” can be a value between 0 and 100%, and the value of white ink so computed is bounded between the range 0 to 100%.

31. The system of claim 26, wherein the relationship, white ink%=(100−background ink) %, to determine the amount of white ink to be laid down is used when both black ink and background ink is applied at the same place.

32. The system of claim 26, wherein when both background ink and black ink are used at the same place, the use of white ink is optimized by adapting the relationship: white ink% =(100−background ink) %.

33. The system of claim 26, wherein the embedded apparatus comprises:
an input device;
an output device; and
a controller.

34. The system of claim 33, wherein the input device comprises:
a substrate having any color other than white;
white ink;
inkset; and
a color-measurement means to measure through the controller the color value of target patches printed on a color media.

35. The system of claim 33, wherein the output device comprises:
a printing means selectable as one of an offline printing means and an online printing means;
output patches generatable by the controller and readable by a measuring means for feeding to the controller for calibration and profiling; and
a linearization table and color profile capable of outputting the calibrated and profiled inkset data for printing on a colored background adapted by white ink.

36. An improved embedded system for online or offline printing on a colored background based on automatic generation of a white ink layer/underbase including production of modified separations, the system comprising:
a) an embedded apparatus for receiving input data respecting an image printable on the colored background, the image constituting one of color and grayscale and containing transparency information in explicit or in implicit form encoded with the image data, the apparatus processing the input data and outputting white layer/underbase information including modified separation;
b) a dual-acting device capable of acting in a first aspect as a plate making or film generating means in respect of offline printing, and in a second aspect acting as a print controller in respect of online printing; and
c) a printing device selected from a group comprising an offset printing device and a screen printing device when offline printing is used, selected from a group comprising an inkjet printer and a laser printer when online printing is used, and one printing device from each group when both offline and online printing are used.

37. A process to determine the amount of white ink to be used in a process of printing using an inkset that is composed of regular inks and having either black ink and background or both comprising:
Step 1—Determining if the ink combination to be printed involves any black ink or background ink? If yes, then go to step 2 or else go to step 8.
Step 2—Determining if the ink combination to be printed involves use of background ink only? If yes, then go to step 3 or else go to step 4.
Step 3—The white ink percentage is computed as per the relationship: white ink %=(100−background ink) %. Go to Step 9.
Step 4—Determining if the ink combination to be printed involves use of black ink only? If yes, then go to step 5 or else go to step 6.
Step 5—The white ink percentage is as determined using the equation white ink %=K×(100−black ink)%+Const, where “K” is a weight that can assume any real number, “Const” can be a value between 0 and 100%, and, the value of white ink so computed is bounded by the range 0 to 100%. Go to Step 9.
Step 6—Determining if the ink combination to be printed involves use of both black ink and background ink? If yes, then go to step 7 or else go to step 8.
Step 7—The white ink percentage is determined using the equation: white ink%=(100−background ink)%. Go to Step 9.
Step 8—The white ink percentage is 100%.
Step 9—End.

38. A process of calibrating and profiling a colored media using an inkset on a printer with adaptation of white ink as defined by the method of claim 33, comprising the steps of:
determining an ink limit by generating a plurality of patches or an ink limit target using a given inkset with several combinations of inks at different percentages including identification of a patch with the highest combined ink percentage which does not bleed, puddle or feather;
linearzing or calibrating the printer response by printing patches or a linearization target with various percentages of individual inks and inputting the data by a measuring means to generate a linearization table;
using the calibrated response of the printer and printing patches of various known combinations from the given inkset or profiling target which forms the basis of a forward relationship between the ink values and the generated color, the color values from the printed target being useable by an ink-model during the process of profile creation; and
generating a color profile based on color data read from a printed profile target by the measuring means, the color profile defining the forward and the backward relationship between a given color and the ink percentages.

39. The process of claim 38, wherein linearization of white ink comprises printing a white ink chart or white ink linearization target with values ranging from 100% to 0% and generation of a white ink linearization table that correlates linear values to non-linear input values of white ink percentages and vice versa.

40. The process of claim 38, further comprising computing a weighting factor “WF” to relate the values represented by % value of white ink to the same % value of colored ink in the inkset equal on an absolute scale, the weighting factor being evaluated based on the relationship, WF=(Ink amount by weight used to print 100% patch of white ink)/(Ink amount by weight used to print 100% patch of any regular color ink).

41. The process of claim 40, further comprising computation of a total ink limit based on an ink limit target printed, wherein the computation comprises:
identifying a color patch having a maximum amount of ink with no puddling, bleeding, or feathering.
determining the percentage of colored ink used for this patch and letting this be “TC”;
determining the amount of white ink printed for this patch and letting this value be “TW”; and
using the weighting factor, the total ink limit “TIL” is defined by the relationship, TIL %=WF×TW+TC.

42. A process of calibrating and profiling a colored media using white ink, comprising at least one of:
a) using a solid colored background as an ink participating in color formulation during the printing;
b) adapting white ink in combination with black ink;
c) adapting white ink when both black ink and background ink are used at same location on the media; and
d) adapting white ink and calibrating and profiling.

43. A method to determine the value of a background color in the input colorspace, comprising:
establishing the input colorspace with gamut volume that encompasses a gamut volume of the input image space as well as the color of the background if the background color is used as an ink in printing, wherein such input colorspace can be the image colorspace or any colorspace having the gamut volume of the image colorspace as a subset;
establishing the output colorspace defined by the inkset used for printing, wherein the colorspace also includes background ink and black ink either together or alone.
establishing a transformation to convert color values from the input colorspace to the output colorspace and vice versa; and
using the transformation to determine the value of 100% background ink from the output colorspace to the input colorspace.

44. A method to compute the amount of white ink and modified ink separations from the given input color “R” in the input colorspace, when printing on substrates having a colored background with the use of the background color as an ink along with optimized coverage of white ink under black ink, the method comprising:
Step 1—Establish a transformation to convert color values from the input colorspace to the output colorspace.
Step 2—Determine the printer primaries “P” by transforming the color “R” from the input colorspace to the output colorspace using the transformation established in Step 1.
Step 3 If the amount of white ink to be used under black ink is to be optimized then go to step 4 else go to step 7.
Step 4—If “P” contains 0% for background ink and 0% for black ink then assign the value of the white ink “W” as 100% and go to Step 10, else go to Step 5.
Step 5—If a background ink value in “P” is not 0% then assign the white ink “W”=(100−background ink) %. Go to step 9, else go to step 6.
Step 6—assign the white ink “W”=K×(100−Black ink)+Const %, where “K” is a weight that can assume any real number, “Const” is a value between 0 and 100%, and the value of white ink so computed is bounded between the range 0 to 100%, and go to Step 10.
Step 7—If “P” contains 0% for background ink then assign the value of the white ink “W” as 100% and go to Step 10, else go to Step 8.
Step 8—Assign the white ink “W”=(100−Background ink) %.
Step 9—Assign the background ink value of 0% in “P”.
Step 10—The value for printing primaries is represented by “P” and white ink by “W”.

45. A method of generating white ink layer/underbase information and suitable printer primaries data from a given image to enable printing on substrates having a colored background with use of the background color as ink participating in color formation along with optimized coverage of white ink under black color, comprising:
a) identifying the pixels applicable or discardable for generating white ink by adapting the opacity data in the given image, wherein for a discardable pixel, a set of printing primaries “P” has 0 values and white ink “W” has a 0 value.
b) computing the value color value “BC” of 100% background ink in the input color space as defined by method of claim 46.
c) for the applicable pixel with the color value “C”, computing the color “R” corresponding to the opacity data to be adapted for primaries and color generation as defined by the relation “R”=(((100−Opacity))×BC+Opacity×C)/100.
d) generating the white ink layer/underbase data “W” along with modified printer primaries data “P” for the color “R”
i) identifying the pixels applicable or discardable for generating white ink by adapting the opacity data in the given image, wherein for a discardable pixel, a set of printing primaries “P” has 0 values and white ink “W” has 0 value.
ii) finding the value of white color in an input colorspace “WC”, wherein WC is the brightest neutral in the input colorspace.
iii) for the applicable pixel with the color value “C”, computing the color “R” corresponding to the opacity data to be adapted for primaries/color generation as defined by the relation “R”=(((100−Opacity))×WC+Opacity×C)/100.
iv) generating the white ink layer/underbase data “W” along with modified printer primaries data “P” for the color “R”,
wherein the black printing primary data in respect of other printing colors is adapted to create a white ink layer/underbase on colored substrate.

46. A method to compute the amount of white ink and modified ink separations from the given input color “R”, when printing on substrates having colored background with only optimized coverage of white ink under black color, the method comprising:
Step 1—Establish a transformation to convert the color values from the input colorspace to the output colorspace.
Step 2—Determine the printer primaries “P” by transforming the color “R” from the input colorspace to the output colorspace using the transformations established in Step 1.
Step 3—On the basis of a value of black ink in “P”, compute the white ink “TW”=K×(100−Black ink)+Const %, where “K” is weight that can assume any real number, “Const” can be a value between 0 and 100%, and the value of white ink “TW” so computed is bounded between the range 0 to 100%, and compute the final value of white ink to be used as “W”=((Opacity×TW)/100)%.
Step 4—The value for printing primaries is represented by “P” and white ink by “W”.

47. A method of generating white ink layer/underbase information and suitable printer primaries data from a given image to enable printing on substrates having a colored background with optimized coverage of white ink under black color, comprising the steps of:
a) identifying the pixels applicable or discardable for generating white ink by adapting the opacity data in the given image, wherein for a discardable pixel, a set of printing primaries “P” has 0 values and white ink “W” has 0 value.
b) finding the value of white color in an input colorspace “WC”, wherein WC is the brightest neutral in the input colorspace.
c) for the applicable pixel with the color value “C”, computing the color “R” corresponding to the opacity data to be adapted for primaries/color generation as defined by the relation “R”=(((100−Opacity))×WC+Opacity×C)/100.
d) generating the white ink layer/underbase data “W” along with modified printer primaries data “P” for the color “R” based on the method defined by claim 49.

48. The method of claim 45, wherein printing colors/primaries are variable based on the type of printer being adapted and the color of the background if used as an ink, and wherein all the printers include black as a printing color/primary.

49. The method of claim 45, wherein the black printing primary data in respect of other printing colors is adapted to create a white ink layer/underbase on colored substrate.

50. The method as claimed in claim 47, wherein black printing primary data in respect of other printing colors is adapted to create a white ink layer/underbase on the colored substrate.
